(19) United States
(12) Patent Application Publication
(10) Pub. No.: US 2005/0163349 A1
(43) Pub. Date: Jul. 28, 2005

(54) System and method for assessing motor and locomotor deficits and recovery therefrom

(76) Inventors: Daniela Brunner, Riverdale, NY (US); William P. Ross, Saranac Lake, NY (US); David Larose, Pittsburgh, PA (US)

Correspondence Address: MORGAN & FINNEGAN, L.L.P., 3 WORLD FINANCIAL CENTER, NEW YORK, NY, 10281-2101, US

(21) Appl. No.: 10/861,811

(22) Filed: Jun. 4, 2004

Related U.S. Application Data
(60) Provisional application No. 60/476,581, filed on Jun. 6, 2003.

(51) Int. Cl. G06K 9/00

(52) U.S. Cl. 382/110

(57) ABSTRACT

An automated intelligent computer system for analyzing motor or locomotor behavior and method of use is provided. The system comprises an automatic, objective, fast and consistent assessment of the level of injury and course of recovery in animal models of spinal cord injury and other gait and motor coordination disorders. The system also is useful for analyzing other types of motor or neurologic dysfunction.

### BACKGROUND OF THE INVENTION

Disorders of motor function due to accidental injury, stroke and neurodegenerative disorders, together with disorders of mental health, are the most crippling human ailments. Spinal cord injury (SCI), for example, involves damage of the spinal cord by contusion, compression, or laceration causing loss of sensation, motor and reflex function below the point of injury, and often bowel and bladder dysfunction, hyperalgesia and sexual dysfunction. SCI patients suffer major chronic dysfunction that affects all aspects of their life.

Therapeutic drugs or other beneficial interventions indicated for spinal cord injury and other neurological conditions are developed using animal models for which assessment of locomotor behavior, gait and motor coordination are important measures of long-term functional recovery. However, assessing the degree of motor dysfunction in an animal model, whether acutely or over a longer term, is a difficult challenge because the methods relied upon involve subjective scoring of symptoms. Current methods of assessing locomotor behavior include the measurement of motor coordination and skill acquisition in the rotarod test, of muscular strength with the grip strength apparatus, of locomotor activity with infrared video tracking in open field, of motor coordination in the grid test and of gait in the paw print tests (video assisted and with force transducers). The ideal system for gait analysis would be analogous to the infrared technology based on reflective markers positioned at the joints. Such systems have been extensively and successfully used in humans and large mammals, but are less suitable in rodents due to the cost, the size differences between the original large mammals used for development and rodents, and the difficulty of attaching fixed joint markers to loose skin.

For example, rat locomotor behavior, in the context of SCI, is commonly assessed using the a 21-point open field locomotion score developed by Basso, Beattie, and Bresnahan (BBB), which was developed in order to overcome the limitations of existing rating scales for studying open field locomotion (Basso, et al., J. Neurotrauma, 12(1): 1-21, 1995). The scoring categories of the expanded scale are based upon the observed sequence of locomotor recovery patterns and take into consideration the early (BBB score from 0 to 7), intermediate (8-13) and late phases (14-21) of recovery (ibid.).

There is evidence that the BBB Locomotor Rating Scale correlates with other indices of injury, such as the amount of gliosis or scarring following injury. Thus, the BBB scale is a sensitive test that identifies both SCI injury severity and recovery by predicting histological outcomes.

Subjective evaluation and low throughput place severe limitations on the accuracy and reproducibility of the BBB test, however. The BBB open-field locomotor rating scale, currently the most widely accepted behavioral outcome measure for animal models of SCI, is a labor-intensive, partially subjective measure that, like all such measures, is prone to training effects and inter-rater variability.

The BBB scale is currently the only validated scale for assessment of spinal cord injuries in animal models. There are, however, three main disadvantages of using this scale in assessing the recovery from SCI: subjectivity and variability of measurements, discrete classification of impairment, and visual occlusion. Because the measurements are subjective and variable, it is sometimes difficult to assess the amount and frequency of joint flexion and the degree of trunk instability. The same people have to perform all the testing in order to minimize inter-rater subjective variability. BBB scale classifies the impairments as discrete categories. Most measures of the human-based BBB scores are taken on an ordinal scale (e.g. a scale with three levels such as “none”, “slight” and “extensive” that only have a relation of order but lack a proportional relationship to the degree of impairment). This creates a problem in that a slight error in the subjective measurement may result in a large change in the BBB score. Finally, visual assessment can be hampered by the animal's body occluding the field of vision. In the early phases of recovery rats leaning on one side will preclude assessment of function of the limb placed under the body. BBB also provides limited information, which in turn may prevent assessment of more subtle motor deficits or recovery.

Manual observation of animals exhibiting other types of motor or neurological deficits is also limited with regard to some of the more subtle deficits or recovery, and is labor intensive. Such manual observation also suffers from the same disadvantages of BBB, including subjectivity and variability of measurements and visual occlusion.

### SUMMARY OF THE INVENTION

The invention comprises a system and method for capturing and analyzing movement and locomotor coordination information from an animal (the term animal is used throughout the invention to refer to an animal or human). The system is an automated intelligent computer system that captures and scores locomotor coordination in an animal, including but not limited to gait and motor coordination, movement and flexion of limbs, position of abdomen, tail, limbs and paws, and body posture.

In one aspect, the invention comprises an automated system to measure SCI effects in small mammals such as rats and mice. In another aspect, the system can be of use for the assessment of motor function in other models of neurological dysfunction such as transgenic and knockout mice. The system of the invention allows for a more objective, faster and more consistent assessment of the degree of injury and course of recovery in animal models, such as, for example SCI, which also can be applied to other gait and motor coordination disorders.

The invention is particularly suited to analyzing deficits related to spinal cord injury and recovery therefrom, as well as the effects of therapeutic agents or interventions designed to aid recovery from SCI. The system is also adaptable to capture other aspects of animal movement that may be used to analyze a myriad of other motor or neurological deficits and evaluate the therapeutic efficacy of pharmacological agents or interventions intended to relieve or cure such deficits. The invention is expected to be useful to evaluate lesioned, knockout, or transgenic animals as potential animal models of motor or neurological injury or disease. The invention also provides a system that may be used to develop new treatments for motor or neurological dysfunction.

The invention captures at least two aspects of motor coordination, the coordinated movement of different parts of the body and the degree of complexity of the motor activity. The coordinated movement of different parts of the body is used to determine if the observed locomotor activity is normal or abnormal when compared to a naive or a baseline animal behavior. The degree of complexity of motor activity is used to classify locomotor activities of an animal into various categories ranging from random and uncorrelated movement to highly predictable and coordinated movement, based on a validated scale for the animal behavior to be observed. The degree of complexity can be continuous or ordinal. The animal coordination can be measured for various parts of the body, such as, for example the hindlimb, forelimb and tail. The baseline behavior can be obtained from the same animal at a different time, for example prior to injury, genetic manipulation or administering of drug. Alternatively, the baseline behavior can be a database consisting of the general expected behavior from the related species.

In one embodiment of the invention, the locomotor coordination activity and movement of the animal is compared to a validated scale for assessing the degree of injury and recovery, such as the BBB scale for SCI in rats. In another embodiment, the invention is used to assess the locomotor coordination of other animals (or humans) and evaluate the degree of recovery or deterioration based on the appropriate scale to assess the specific condition under study. The invention may also be used to monitor the course of recovery or course of impairment over time from an injury or a genetic mutation. Furthermore, it can be used to assess the ability to stop the course of impairment or to evaluate the improvement due to treatment. Group differences, for example, due to lesion or genetic manipulation, can be assessed by comparing and analyzing the information obtained using the invention.

In yet another embodiment of the invention, the apparatus can be used to collect locomotor coordination, from lesioned animals, genetically manipulated animals, animals exposed to known or experimental drugs, or pain-inducing stimuli, to generate signatures for these experimental manipulations, based on the aggregate behavior of the tested animals. In such embodiment, the baseline behavior is not known a priori and the invention is used to generate a scale or signature for the specific locomotor related activity.

In one embodiment, the invention is a system comprising an arena, including a floor and walls through which animals movements are observed, video cameras for recording ventral views and lateral (side) views of the animal, and a computer system that automatically captures and scores aspects locomotor activity, such as for example, gait and motor coordination, as well as the posture of the animal. In a preferred embodiment, the system includes a color illuminated glass floor that ensures capture of a measure of contact of the abdomen or of the paws, which is proportional to paw pressure. In another preferred embodiment, the system uses video segmentation, a process through which pixels from video frames are filtered to provide a minimal image of the targeted object, for example the outline of the animal, to capture information that can be used for subsequent model fitting to anatomically correct images of the animal.

In another embodiment, the arena consists of a running wheel, comprising side walls, which limits the area over which an animal can move and thereby facilitates the capture of video data.

The system further includes computer vision, which permits capture of anatomical positioning including, but not limited to, hindlimb movement or position, of forelimb movement or position, of tail movement or position, and/or of abdominal and paw movement or position.

The computer vision aspect of the invention may employ, for example, a 21-point open field locomotion score, developed by Basso, Beattie and Bresnahan (BBB), to score and validate early SCI recovery in rats (Basso et al., J. Neurotrauma, 12(1):1-21 1995). Computer vision scores mimic the type of assessment required for the BBB scale and are used to build a synthetic BBB scale that is continuous in nature. The synthetic BBB scale may then be correlated to predefined levels of early recovery phases as determined from human rated recovery phases, provide an assessment of intensity of injury and degree of recovery. It is to be understood that the invention is not limited to building a synthetic scale relating to 21-point open field BBB scale for SCI in rats, or to the BBB scale. The invention is applicable to any validated scale that utilizes an animal locomotor behavior.

In one embodiment of the invention video cameras may be placed in pairs to provide stereovision. Preferably such video cameras obtain, either directly or indirectly, both ventral and lateral views of the test animal. When images from the ventral camera is combined with images from lateral camera, stereo three-dimensional vision imaging is possible.

### BRIEF DESCRIPTION OF DRAWINGS

FIG. 1 depicts an apparatus consisting of a normal open field (not to scale) with a transparent glass bottom. The glass is illuminated from the side. This arrangement ensures light will be diffracted by contact with the glass, allowing the detection of the paws and other body parts in close contact with the bottom surface. One ventral view camera captures the general view and the illuminated body parts, whereas several side cameras capture the lateral views.

FIG. 2 depicts the use of a color illuminated floor to capture contact of the animal with the floor. In this example, illumination is provided by red LEDs that illuminate points of contact in red. As the background of the apparatus is blue, the outline of the animal is clearly seen. In this image, a normal rat is walking across the surface. Note only three of the paws are making contact and are therefore illuminated in bright red. No other part of the body is touching.

FIG. 3 depicts an arena consisting of a running wheel. The floor boundaries are limited by side walls to constrain the area of movement. The wheel can be moved by the rat or by a motor. Bottom and side vision provide imaging for computer vision. Inset: the prototype during early development.

FIG. 4 depicts marking and capturing joint points through computer vision. (A) A rat in the open field with joint markers. (B) Processing of the image increases color contrast. (C) Segmentation removes all pixels but those corresponding to joint markers.

FIG. 5 depicts a side view showing different stages of information processing. Each video frame is first filtered to remove everything that belongs to the background and not to the subject (background subtraction). Care is given to the preservation of the joint marking. Next phases include recognizing limb outlines and joint markers. The last step is to fit a simple 2D model to the joints to allowed estimation of joint angles.

FIG. 6 depicts a ventral view of a rat in different stages of recovery. To note are the illuminated areas. A) hindpaws are dragging dorsally, with contact of abdomen and tail. B) hindpaws are placed correctly and support some weight. C) limbs support all weight, no contact of abdomen or tail.

FIG. 7 depicts the ventral view of a lesioned rat in the running wheel arena. The rat is in the first phase of recovery and therefore is dragging its legs. The abdomen is in contact with the surface, as it supports the weight of the back of the body. Note the difference with the bottom view of a normal rat (FIG. 6C).

FIG. 8 depicts paw print analysis showing the hind and forepaws and typical parameters.

FIG. 9 depicts left and right camera views from a stereo camera pair.

FIG. 10 depicts a top view of possible camera configuration showing two stereo pairs.

FIG. 11 depicts a top view of possible eight camera stereo setup. Cameras may be synchronized so frames from each video stream correspond to the same time point.

FIG. 12 depicts a synthetic skeleton rodent model showing joints, limb segments, hip, skull and vertebrae. Putative angles and distances necessary for gait and motor coordination analysis are noted. 1. Tail elevation; 2. Hip elevation; 3. Hip angle; 4. Femur angle; 5. Tibia angle; 6. Paw angle; 7. Paw elevation; 8. Knee elevation; 9. Hip advancement angle; 10. Sagittal plane angle.

FIG. 13 depicts a side view of a rat skeleton adapted from R. J. Olds & J. R. Olds, A Colour Atlas of the Rat—Dissection Guide. Red arrows indicate joints to be marked on the skin. Numbers refer to skeletal features: 1. Skull; 2. zygomatic arch; 3. mandible; 4. tympanic bulla; 5. seven cervical vertebrae; 6. thirteen thoracic vertebrae; 7. six lumbar vertebrae; 8. four sacral vertebrae; 9. about twenty-seven caudal vertebrae; 10. pelvis; 11. femur; 12. patella; 13. tibia; 14. fibula; 15. tarsus; 16. metatarsus; 17. scapula; 18. humerus; 19. ribs; 20. sternum; 21 radius; 22. ulna; 23. carpus; 24. metacarpals; 25. phalanges with claws.

FIG. 14 is a graphic representation of a sequence of two representative side views showing slight flexion of three joints associated with leg movement. In one embodiment, the simple 2D model shown in the figure may be used to fit the extracted joint markings and guide the calculation of joint angles.

FIG. 15 is a flow diagram exemplifying how joint angles are calculated using computer vision.

FIG. 16 depicts a ventral view of a hindpaw which is: A) not in contact with the illuminated glass, B) in contact with the illuminated glass, with some weight applied; and C) in contact with the illuminated glass, with considerable weight applied.

### DETAILED DESCRIPTION OF THE INVENTION

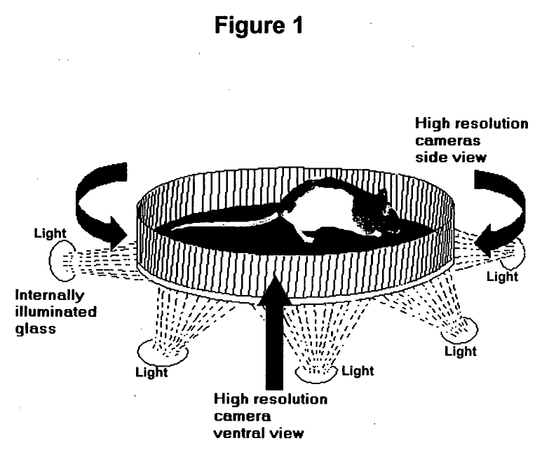

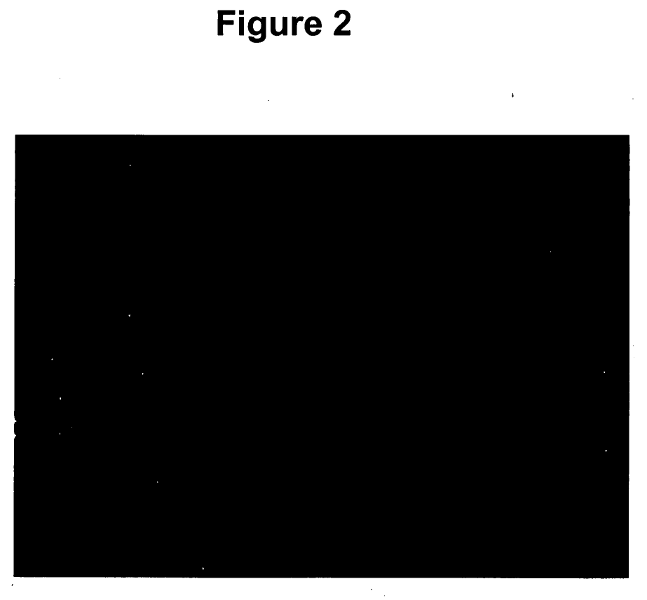

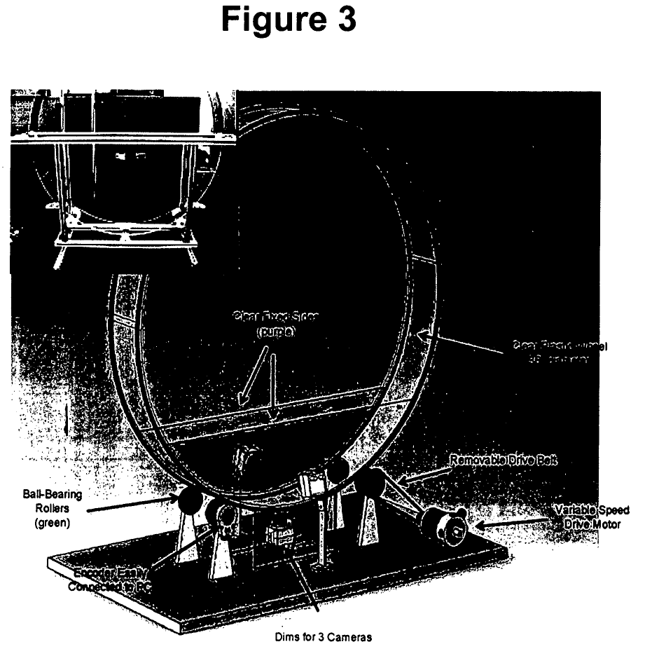

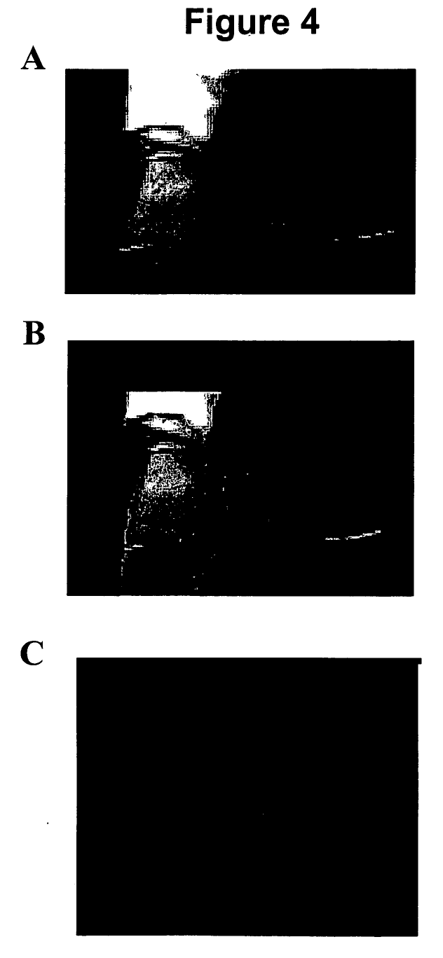

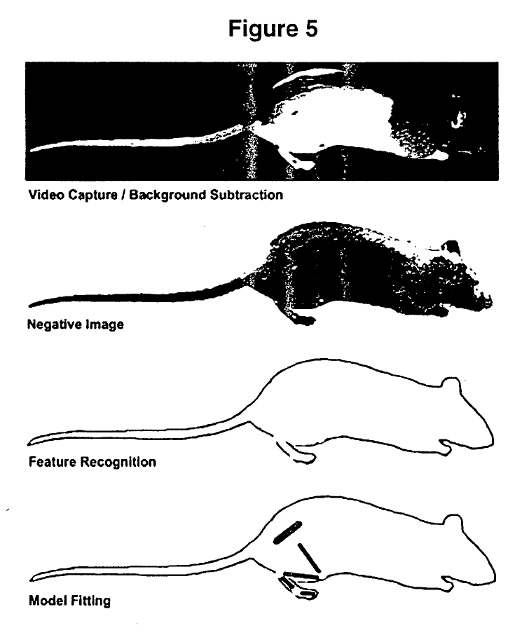

This invention provides a system of automated locomotor analysis in freely moving animals, such as a mouse, for example, for an objective and comprehensive assessment of locomotor activity, such as, for example, gait and motor coordination, as well as posture. Accordingly, in one embodiment, this invention provides a system including apparatus and methods for the analysis of animals, such as transgenic and knockout rodents that mimic human conditions such as Amyotrophic Lateral Sclerosis (ALS), Parkinson's Disease (PD), Huntington's Disease (HD), peripheral neuropathy and dystonia, and other neuromuscular and neurodegenerative disorders, as well as any other disorders that affect locomotor behavior directly or indirectly. It also provides a way to assess motor function in SCI The system of this invention provides several advantages over existing systems that measure animal movement. These advantages include 1) automatically quantifying motor function in animal models of motor dysfunction; 2) quantifying paw position and leg movement by using both a ventral and a side view; 3) augmenting the throughput of behavioral assessment; 4) fitting limb outline and joint position to an anatomically correct skeleton to measure joint movements thereby ensuring greater accuracy of measurement; 5) providing a measure of the extent of animal and floor contact, allowing a measure of the force exerted on the floor surface; 6) providing a continuous rather than categorical scale of measurement, thus allowing greater sensitivity to subtle motor dysfunction; and 7) allowing the detection of subtle features of movement that are not normally recorded by human observers. The invention comprises an arena in which an animal is placed and observed, video cameras, and a computer system. As shown in FIG. 1, in a preferred embodiment, the arena comprises a transparent floor and circular sidewalls, which allow video imaging of the animal by way of placement of video cameras (preferably high quality) below the floor and on the sides to permit ventral and lateral views of the animal. In one embodiment, the SmartCube (U.S. patent application Ser. No. 10/147,336, published as US 2003/0083822 A2 which is incorporated herein by reference) is the arena used for testing the animal. Such view may be obtained directly, e.g. by placing video cameras in at least two positions on the sidewalls. In another embodiment, video images may be obtained indirectly, for example by the use of mirrors. In another embodiment, the video cameras used may be thermographic cameras which can be used to detect subtle temperature changes in the observed animal. The use of thermographic cameras is of particular use in correlating locomotor activity with pain and associated inflammation. The computer system component of the invention automatically captures and scores locomotor activity, preferably gait and motor coordination. It can also automatically capture limb movement and position, joint position and flexion, body movement, position and posture, tail movement and position, or other features related to movement (or lack of movement) or disorders that affect locomotor activity, preferably neurological disorders. Other movements associated with drug activity, such as stereotype or forepaw treading or Straub tail, or movements associated with symptoms of drug withdrawal may also be video captured and analyzed. In addition, movements associated with pain and inflammation, in the presence or absence of a therapeutic agent, preferably an analgesic or anti-inflammatory drug, can also be assessed. In one embodiment, joint movement is successfully captured by the use of a color illuminated floor that can capture the amount of contact of, for example, paws as seen in FIG. 2, wherein the amount of contact is proportional to paw pressure. See Clarke, Physiology & Behavior, 62: 951-54 (1995). Transparent floors with glass plates are preferred. In another embodiment, the arena consists of a running wheel, comprising side walls, which confines the rat to a narrower area, as shown in FIG. 3, and thus facilitates video data collection. Limb movement and flexion is captured by marking the joints of the animal and capturing the position of limbs and joints by computer vision. Video segmentation is used to create a minimal image, such as the outline of the animal. Computer algorithms may be used to find limb outlines with minimal joint landmark markings on the animals. See FIG. 4 The computer vision algorithms are then fitted to an anatomically correct computer skeleton model. The computer skeleton model is based on the anatomy of real rats (or other animals), and is used to fit the limbs and joints extracted from the video segmentation process. Video artifacts are minimized by restricting the angular movements of the limb segments. The system is able to achieve high throughput and requires minimal human intervention and preparation Central to the automated system of the invention is computer vision. Computer vision captures video images from multiple views and combines the views using different methods selected based on the features to be measured. In the case of some features, the application of two-dimensional (2D) methods and relevant algorithms is necessary, whereas in the case of other features, three-dimensional (3D) methods and algorithms will be required. Computer vision may also fit the features to separately constructed databases, including, for example, fitting limb outlines and joint markers to an anatomically correct computer skeleton model of a rat, which provides better accuracy of limb position and joint angles. To ensure that the fitted skeleton features actually correspond to the real rat joints, computer vision algorithms are run on baseline video clips of rats, and analyzed frame by frame to maximize the consistency of the fittings. Algorithms are adjusted to improve fitting and reduce variability between frames A preferred embodiment of this invention employs video segmentation, the process through which pixels from video frames are filtered to provide a minimal image of the targeted object using background subtraction. See FIG. 5. In this case the image is the outline of the animal. For example, the subject's behavior is captured 30 times a second by the cameras and is analyzed in real time by the computer. The captured video images should be of sufficient quality to ensure efficient computer vision processing. Appropriate information also may be captured for subsequent model fitting The positions of the video cameras provide either direct or indirect views of the animal in a plurality of axes such that both the motion of limbs and the ability of the animal to support itself can be assessed. In a preferred embodiment, lateral views through the sidewalls and a ventral view through the floor are obtained. Each of these views provides different information, and combined enhance the power of the system of the invention to assess motor function and dysfunction.

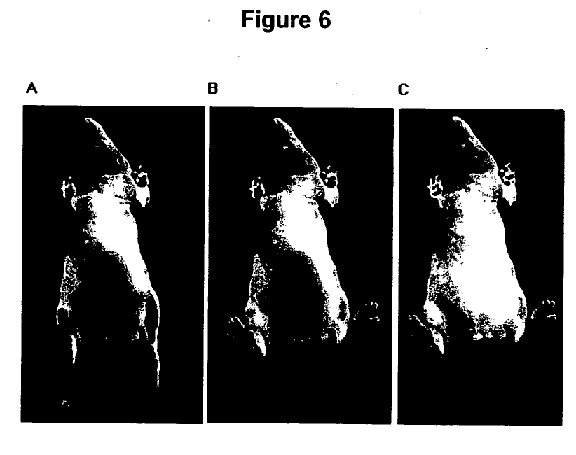

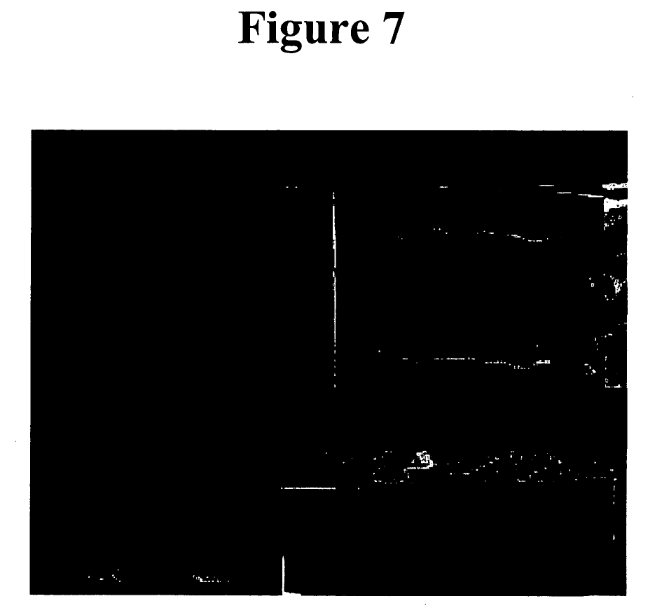

From the ventral view, the aim is to capture the position of the paws, the amount of pressure exerted on the abdomen, and an outline of a paw pressed between the abdomen and the glass (as when the rats or mice lie on a side). See FIGS. 6 and 7. The illuminated glass technique has been used to estimate plantar pressure (Betts et al., Engin. Med., 7:223-238, 1978). It has been shown (Clarke, et al., Physiol. Behav., 62:951-954, 1997; Clarke, K. A., et al., Behav. Res. Methods Instrum., 33(3):422-426, 2001) that the vertical component of the force exerted by the limbs estimated through the analysis of illuminated pixels corresponds closely with the forces measured through a classic force transducer (Clarke K.A. et al., Physiol. Behav., 58:415-419, 1995). The ventral view is particularly useful in cases where an animal is so severely impaired that it is incapable of ambulating.

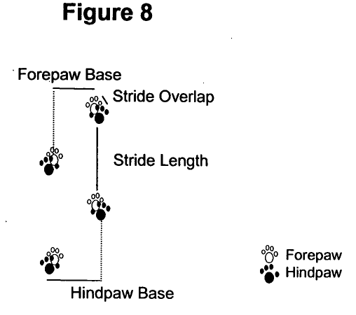

The ventral view allows paw print analysis to assess gait and motor coordination. The system uses the information captured through analysis of illuminated pixels of both hind and forepaws to analyze limb coordination and gait analysis. FIG. 8 shows a typical print of a normal mouse. Parameters to be extracted are the hind and forepaw base, the degree of overlap and the stride length. In addition to these spatial parameters, temporal parameters such as the stride period, phase, and the stance and swing time are analyzed. A continuous measure of limb coordination is also calculated, by estimating the mean number of hindlimb strides per forelimb stride period.

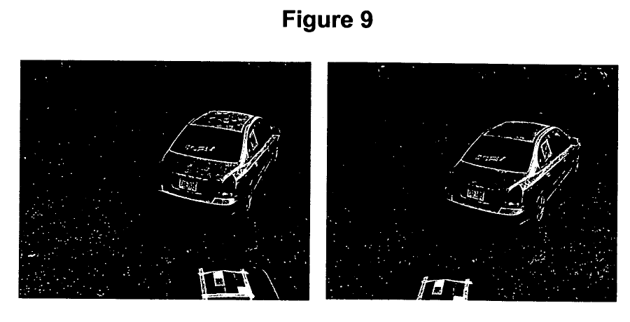

From the lateral view, the system captures the position of the limbs, the amount of support of the abdomen, the stability of the body and position of the tail. The system collects video images of sufficient quality to provide a view of the rat position based on at least 30 frames per second. Each frame is processed to extract the figure of the rat (FIG. 5). For the lateral view, the views from two contiguous cameras are combined to build a 3D model using stereovision, as described below. FIG. 9 shows the view from two contiguous cameras that are processed at the same time and later combined during the stereovision processing.

In another preferred embodiment, stereovision is used to create 2D or 3D models. The system may use one or more of a number of technologies available to acquire 3D images of a scene (Ross, IEEE Conference on Comp. Vision & Pattern Recognition, June 1993). These include sonar, millimeter wave radar, scanning lasers, structured light, and stereovision. The relative performance of these technologies for this application is summarized in Table I:

TABLE I
Comparison of 3D vision technologies

| | | | | | Detectable by the |
|---|---|---|---|---|---|
| | | | | | Experimental |
| Technology | Resolution | Accuracy | Speed | Cost | Subject |
| Sonar | Very Low | Very Low | Low | Low | No |
| Radar | Very Low | Low | High | High | No |
| Scanning | High | High | Med | High | Sometimes |
| Laser | | | | | |
| Structured | High | High | Med | Med | Sometimes |
| Light | | | | | |
| Stereovision | High | High | High | Low | No |

Sonar and radar have proven useful in many outdoor domains, however, both have severe resolution limitations that make them unsuitable for an application of this type. Scanning laser range finders are expensive and fragile mechanical devices. Structured light based systems are workable, but are limited in their ability to image fast motions, and they project a pattern of light which may be visible (and distracting) to the test subjects. Stereovision is the preferred technology to acquire 3D images for the invention. Stereovision has been used for many years in the robotics community (including on Mars Pathfinder) and good algorithms are available to produce excellent 3D images of a scene.

Stereovision techniques offer a number of other advantages as well. Stereovision relies on low-cost video technology that uses little power, is mechanically reliable, and emits no distracting light. A stereo system also allows more flexibility since most of the work of producing a stereo range image is performed by software that can easily be adapted to a variety of situations.

Stereovision relies on images from two (or more) closely spaced cameras that are typically arranged along a horizontal “baseline”. Images (or full-speed video) are taken simultaneously from all of the cameras. Once a time-synchronized set of images has been taken, it can be converted into a 3D range image. The fundamental principle behind stereovision is that, when the same scene is imaged by more than one camera, objects in the scene are shifted between camera images by an amount that is inversely proportional to their distance from the cameras. To find out the distance to every point in a scene, it is therefore necessary to match each point in one image with corresponding points in the other images. There have been many successful methods used to perform this matching, including feature-based matching, multi-resolution matching, and even analog hardware-based matching. In the present invention, the matching uses the SSSD (the sum of the sum of the squared differences) algorithm. This technique has many advantages (Kanade & Okutomi, IEEE Trans. on Pattern analysis & Machine Intelligence, 16(9):920-932, 1994).

The SSSD method is mathematically simple and produces good results. The technique also places no limitation on the scope of the stereo match. This allows production of small, low resolution images to be performed as easily as production of larger, high resolution images. Even more importantly, the technique easily allows the incorporation of additional cameras. Because of its regularity, the SSSD method is easily adaptable to both multiple instructions-multiple data (MIMD) and single instruction-multiple data (SIMD) computer types as well as to streaming SIMD architectures. Lastly, the SSSD method makes it easy to compute a confidence measure for each pixel in the range image that can be used to detect and reject errors.

The sum of squared differences (SSD) method is used to determine which pixels match each other between the input images. Several clues can be used to match pixels. The first clue is that, due to the geometry of the cameras, which are arranged in a line, matching pixels will occur on the same scanline in each image. Due to the baseline of the cameras, the disparity (horizontal displacement of a pixel) must fall within a certain range. For each pixel in the first image, a small range of pixels on a single scanline in each of the other images is analyzed for matches. The pixel in this range that produces the best match is considered to be the same point in the real scene. Once this match is identified, the range to that point in the scene may be immediately calculated since the fixed camera geometry, baseline and lens parameters are known. The crucial process is determining which in the range of possible pixels is the right match. For two images the SSD method works by comparing a small window around the pixel in the original image to a window around each of the candidate pixels in the other image. The windows are compared by summing the absolute (or squared) differences between the corresponding pixels in each window. This yields a score for each pixel in the range. The pixel with the lowest score has a window around it that differs the least from the window around the original pixel in the right-hand image.

The SSSD method is simply the extension of the SSD technique to 3 or more images. In a preferred embodiment, three or more camera images are obtained; for each pixel an SSD match between the right-hand image and the center image as well as between the right-hand and left-hand images is obtained. For each disparity “D”, the window shifted by D pixels in the left-hand image and by only D/2 pixels in the center image. When the SSD of both pairs of windows has been computed, the two SSD values are summed and examined to produce a single score (the SSSD) for that disparity value.

Variable SSD window sizes for each pixel in the image can be used to achieve the best results for each portion of the image. Also, disparities can be sampled at the sub-pixel level (with interpolation of image pixels) to increase depth resolution. These enhancements typically give superior results.

Stereovision requires large amounts of computation to perform the matching between pixels. Computational performance may be improved in the context of SSSD by reversing the order of the computation. Instead of finding the SSD between two sets of windows and then summing these values, the differences between the whole images can be computed and summed to produce a single image representing the match at that disparity. The window around each pixel can then be summed to produce the SSSD for that pixel. The summation of these windows can be done very quickly as rolling sums of columns can be kept to speed the computation.

Another technique that reduces computation time is to reduce the size of the input images. Analysis of the original color camera images allows for operating on regions of interest, such as the area occupied by the test subject, while excluding uninteresting parts of the field of view.

The simplicity and symmetry of the SSD computation should make it easy to adapt the algorithm to take advantage of new high performance computing architectures such as Intel's streaming SIMD processor extensions and new hyper threading architecture. These adaptations allow maximal performance from relatively inexpensive commodity computing platforms. The SSD computation is also readily adaptable to multiprocessing systems such as the Intel Xeon.

The system performs in the 10 to 20 Hz range for high-resolution camera images.

Confidence Measures. Sometimes, the SSSD technique will break down when there is not enough texture in the image to perform a good match. For example, an image of a smooth, white wall will produce the same SSSD score for every disparity; a graph of the SSSD values will look like a flat line. When there is plenty of texture, there is almost always a clear minimum SSSD value on the curve.

To make use of this phenomenon, and maximize the information obtained from a possible furry texture of the subject and minimize that from the flat surfaces that surround it, the system will produce a “confidence” value for each pixel in the range image. This is a measure of the flatness of the SSSD curve. If a pixel in the range image has a confidence level below a pre-defined threshold, it can be ignored as unreliable. The confidence value for each pixel is computed by taking the average of the percent of change between successive SSSD values. The confidence values allow rejection of incorrect pixels and image areas.

Cameras. Stereovision algorithms thrive on high-resolution images with sufficient detail to facilitate matching of pixels. Preferably, the system uses high-resolution cameras with a high-speed digital interface such as IEEE-1394. These features enable connecting multiple cameras to a single computer and provide the image quality required for stereovision.

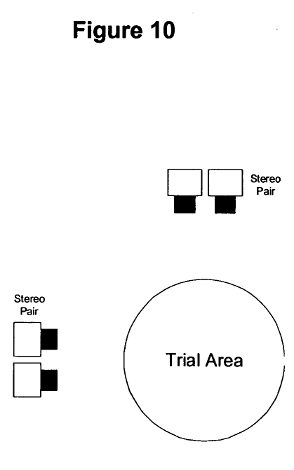

Cameras are arranged in pairs that are closely spaced along a horizontal baseline. This arrangement simplifies computation of the stereo correspondence. FIG. 10 shows a simple arrangement of two stereo pairs observing the entire trial area at right angles to each other. This setup ensures that the software would always have a good profile view of at least one side of the animal.

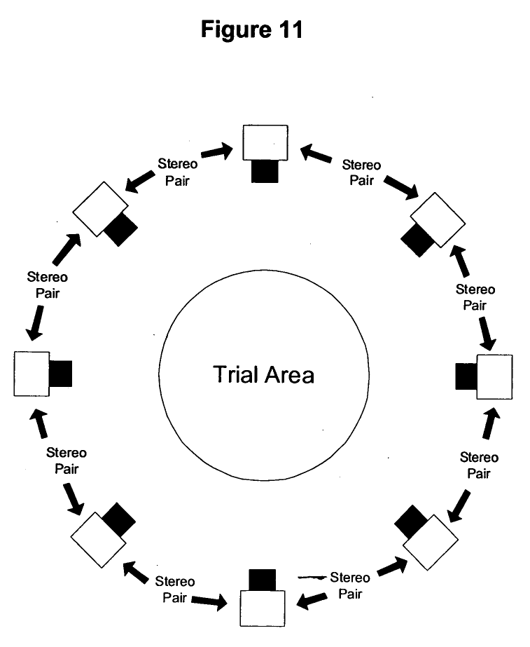

Although it is somewhat easier to deal with closely spaced cameras with parallel image planes (pointing in the same direction), it is also possible to use image rectification techniques to obtain 3D stereo images from cameras with non-parallel image planes. FIG. 11 shows a possible setup using 8 cameras implementing 8 stereo pairs. Such a setup provides 100% coverage of the trial area and good profile views of both sides of the animal at all times.

Cameras are connected to standard, PC-based workstations with sufficient memory to allow both live processing of experimental trials and the archiving of video data for off-line reanalysis (as software is improved) and comparative scoring by human experts. Archiving experimental data will ensure that a minimum of animals is required for validation of the computer system.

The Continuous, Dynamic, Three-Dimensional Animal Model. During an experimental session with an animal, the stereo algorithms provide continuous (10-20 Hz), real-time estimation of the 3D position of the joint marks on the animal's fur or skin. Multiple pairs of stereo cameras provide simultaneous coverage of all of the animal's joints and limbs. During the course of an experimental trial, the system compiles a continuous dynamic 3D model of the animal's movements.

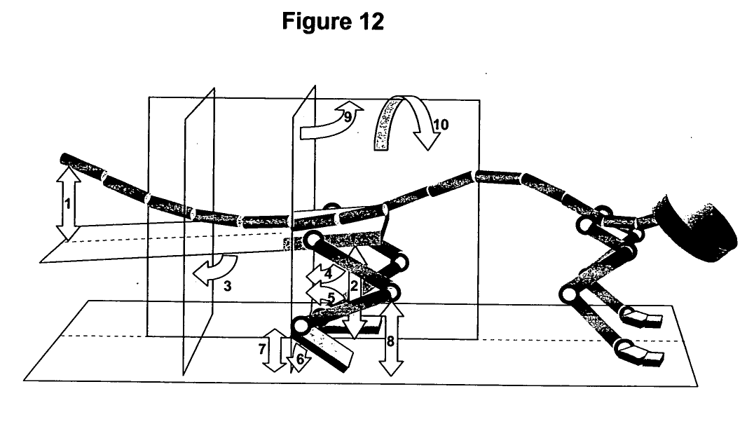

The 3D model is analyzed to extract the positions of the individual limbs and joints. This process is greatly simplified by using color information from the original camera images to locate the joint marks on the animal. The positions of such marks should correlate closely with a simplified skeleton model of the animal (FIG. 12). Poorly correlated samples (such as a leg positioned where a nose should be) can be discarded as probable errors, or avoided through the implementation of smart filters that will restrict the movement of model parameters based on the rat skeleton model. In other words, the skeleton provides a set of restrictions of possible movements, angles and torque.

### Example

### Animal Model for Using Computer Vision to study SCI Recovery in Rats

Animal models of SCI mimic contusive injuries, as seen in the majority of SCI, and may be induced in rats by weight drop or forceps compression methods, which methods are described briefly below for injury at the thoracic level of the spinal cord. Following injury at the thoracic level, for example, animals display paraplegia analogous to SCI in humans. Assessment of injury induced at a lumbar region of the spinal cord will also produce paraplegia, whereas injury induced at the cervical level can produce quadriplegia. The severity of the injury will affect the severity of the paralysis, and may be adjusted, within limits, accordingly.

The weight drop procedure is the most widely accepted method for SCI in animals. Female Long Evans rats are anaesthetized to a surgical level with isoflurane delivered with medical air. All animals are treated with antibiotics to prevent post-surgical infections and analgesics for post-operative pain. The thoracic spinal cord is exposed with a dorsal laminectomy at T9, and a precise contusion injury is delivered to the spinal cord using the weight-drop apparatus developed by Wise and Young (NYU Impactor). Animals are positioned on the device via clamps that grasp the vertebra at T8 and T11. The NYU Impactor employs a sliding weight that can be positioned above the exposed spinal cord. A 10 g weight is built into the device and the distance the weight travels during the free-fall to the spinal cord can be adjusted, but it is typically set at 25 mm. The severity of the contusion injury is related to the distance the weight drops. Transducers in the apparatus collect data regarding the velocity of the weight drop and the compression sustained by the spinal cord. After the injury, the injury site is flushed with saline solution, the overlaying muscle layers are sutured together and the skin wound stapled closed.

For the forceps compression model, female Long Evans hooded rats are anaesthetized with 1.5% inhalation isoflurane. The animals' backs are shaved and the skin covering the thoracic-lumbar region is opened using a surgical blade and the lower thoracic vertebrae are exposed. A laminectomy is made at the vertebral T9-T10 segments to expose the spinal cord. A pair of flat forceps is used to compress the width of the spinal cord to a set distance (generally no more than 0.9 mm) for 15 seconds. Preferably coverslip forceps (4 mm wide×0.5 mm thick; Fine Science Tools, Cat #11074) are used. More preferably coverslip forceps modified to compress the spinal cord to a fixed distance of 0.9, 1.3, or 1.7 mm are used. After the forceps are removed, and the injury site is flushed with saline solution, the overlaying muscle layers are sutured together and the skin wound stapled closed. This model reproducibly causes paraplegia similar to that achieved with the MASCIS weight drop device, the most widely used SCI method, but in less time.

Animal movements are observed by placing an animal in an arena that is connected to an artificial intelligence system that captures and scores locomotor activity, such as gait and motor coordination for example. To ensure appropriate capture of sufficient information, the arena includes a high-quality video camera system.

Motor function in the early phase of recovery in SCI may be analyzed by concentrating information capture on hindlimb functionality. Motor function in the intermediate and later phases of recovery in SCI may be analyzed by capturing information from forelimb and body functionality, as well as abdomen and position.

Two embodiments are described, which address two different phases of recovery from SCI. In one embodiment, for the early phase of recovery of SCI, the functionality of the hindlimbs, in particular the degree of flexion of the hindlimb joints, is analyzed. In another embodiment, for intermediate and late phase of recovery of SCI and for assessment of motor function in animal models other than SCI, functionality of the limbs or hind- and forelimbs are analyzed.

For each of these embodiments, the arena comprises a transparent floor and wall and high quality video cameras are positioned at ventral and at least two side views (FIG. 1). Use of an illuminated glass (Betts and Duckworth, Engineering in Medicine, 7:223-238, 1978) enables registration of limb movements from a ventral view. The system is particularly useful for the intermediate and late phase of recovery, during which paw position, limb coordination, weight support, and tail position are particularly relevant parameters. These parameters are assessed from information captured through the ventral view. In one embodiment, the floor glass is illuminated internally using a color of light distinct from the general colors of the rat, to take advantage of the contrast between those parts in contact with the glass surface and those that are not. In this manner, the amount of pressure from the limb or abdomen on the floor may be measured. For the assessment of the early phase of recovery, hindlimb position (below the body or on the side) and joint flexion information is captured from ventral and lateral views. In one embodiment of the invention, four video cameras placed 1 inch above the floor provide a side view.

In a preferred embodiment used to assess SCI, the automatic system of this invention solves the problems of standard BBB scale described above as follows: Subjectivity and variability of the measures: The novel computer vision based system provides an objective and consistent assessment of the animal movements. Discrete classification of impairment. The computer vision also provides continuous measures on a ratio scale (e.g. joint flexion is measured as a continuous angular measure), which can be the studied in relation to the intensity of the lesion and to the speed of recovery. Visual Occlusion: An automated system that provides both a side and a ventral view of the animal allows complete three-dimensional assessment.

The BBB scale has 21 levels, as detailed in Table II. The text of Table II that is in bold indicates measures that are obtained as a continuous value in the computer-scored system of the invention.

TABLE II

| Level | Description |
|---|---|
| 0 | No observable hindlimb (HL) movement. |
| 1 | Slight movement of one or two joints, usually the hip &/or knee. Slight is |
| | defined as partial joint movement through <50% of the range of joint motion. |
| 2 | Extensive movement of one joint or extensive movement of one joint and |
| | slight movement of one other joint. Extensive is defined as movement through >%50 |
| | of the range of joint motion. |
| 3 | Extensive movement of two joints. |
| 4 | Slight movement of all three HL joints. |
| 5 | Slight movement of two joints and extensive movement of the third. |
| 6 | Extensive movement of two joints and slight movement of the third. |
| 7 | Extensive movement of all three HL joints. |
| 8 | Sweeping with no weight support. Sweeping is defined as rhythmic movement |
| | of HL in which all three joints are extended, then fully flexed and extended |
| | again; animal is usually sidelying, plantar paw surface may or may not contact |
| | ground, and no weight support across the HL is evident. Weight support is |
| | defined as HL extensor contraction during plantar placement of paw or |
| | hindquarter elevation. No weight support implies absence of either. |
| 9 | Plantar paw placement with weight support in stance (i.e. when stationary) |
| | only or frequent to consistent weight-supported dorsal stepping and no |
| | plantar stepping. Dorsal stepping means weight is supported through the |
| | dorsal surface of the paw at some point in the step cycle. Three stepping |
| | patterns are considered dorsal stepping: (1) plantar weight support at liftoff |
| | then the HL is advanced forward and weight support is reestablished through |
| | the dorsal surface of the paw, (2) dorsal weight support at liftoff then the HL is |
| | advanced forward and weight is reestablished through the dorsal surface of the |
| | paw, (3) dorsal weight support at liftoff then the HL is advanced forward and |
| | weight is reestablished through the plantar paw surface. |
| 10 | Occasional weight-supported plantar steps, no forelimb (FL)-HL coordination. |
| | Occasional means less than or equal to half; <50%. FL-HL coordination means |
| | for every forelimb (FL) step, a hindlimb (HL) step is taken, and HL steps |
| | alternate. |
| 11 | Occasional weight-supported plantar steps, occasional FL-HL coordination. |
| 12 | Frequent to consistent weight-supported plantar step and occasional FL-HL |
| | coordination. Frequent means more than half but not always; 51-94%. |
| | Consistent means nearly always or always; 95-100%. |
| 13 | Frequent to consistent weight supported plantar steps and frequent FL-HL |
| | coordination. |
| 14 | Consistent weight-supported plantar steps, consistent FL-HL coordination, |
| | and predominant paw position during locomotion is rotated when it makes |
| | initial contact with the surface as well as just before it is lifted off at the end of |
| | stance or consistent FL-HL coordination and occasional dorsal stepping. |
| | Rotated includes both internally or externally. |
| 15 | Consistent FL-HL coordination and toes are frequently to consistently |
| | dragged across the walking surface; predominant paw position is parallel to |
| | body at initial contact. |
| 16 | Consistent FL-HL coordination during gait and toes are occasionally dragged. |
| | Predominant paw position is parallel at initial contact and rotated at liftoff. |
| 17 | Consistent FL-HL coordination during gain and toes are occasionally |
| | dragged. Predominant paw position is parallel at initial contact and liftoff. |
| 18 | Consistent FL-HL coordination during gait and toes are no longer dragged; |
| | predominant paw position is parallel at initial contact and liftoff. |
| 19 | Consistent FL-HL coordination during gait and toes are no longer dragged; |
| | predominant paw position is parallel at initial contact and liftoff; tail is down |
| | part or all the time. |
| 20 | Consistent coordinated gait; no toe drags; predominant paw position is |
| | parallel at initial contact and liftoff; trunk instability is present; and tail is |
| | consistently up. |
| 21 | Coordinated gait, consistent toe clearance, predominant paw position is |
| | parallel throughout stance, consistent trunk stability tail consistently up. |

The BBB rating scale is a sensitive, if labor-intensive and subjective, test that shows injury severity and recovery by predicting behavioral and histological outcomes. Following moderately severe SCI, most untreated rats recover to a score of 7 after approximately 8 weeks; this is the early phase of recovery. In the intermediate phase of recovery, scores of 8-13 are typical indicating more consistent stepping and forelimb-hindlimb coordination. Scores of 14-21 typical of the late phase of recovery, indicate greater consistency of coordinated gait, more normal foot placement, and balance during gait.

An automated system that captures sufficient information to analyze SCI preferably captures all the features of the BBB scale. The standard scoring using the BBB scale involves placing a rat on an open field and scoring 10 behaviors involving the trunk, tail, left and right hindlimbs of the rats. In one embodiment of this invention, where SCI is measured, the automated system of this invention captures the following 10 important features:
a. Limb Movement. Hip, knee, and ankle movements.
b. Trunk Position. Side or Middle. Prop.
c. Abdomen. Drag, Parallel, High.
d. Paw Placement. Sweep. No support, Weight support.
e. Stepping. Dorsal stepping.
f. Coordination. Forelimb-hindlimb coordination.
g. Toe dragging. Incidence of toe drags.
h. Predominant paw position. Initial Contact and Liftoff.
i. Trunk instability.
j. Tail position.

In particular, the early recovery phase BBB scores 0 to 7 listed in Table II require assessment of the first feature, a: limb movement. Scoring the intermediate and late recovery phases, i.e., scores above 7 in Table II, require assessment of the remainder of the 10 features, b-j.

The automated system of the invention captures these features in addition to other information to provide a broader assessment of motor function than BBB scoring alone. Moreover, the automated capture provides measurement on a continuous scale providing a truer dynamic range to the assessment of motor impairment.

In one aspect of the invention, computer vision is utilized to capture these 10 BBB features. Table III reiterates the features necessary for the scoring of the full BBB scale (“Feature”) and explains the grades used for the BBB scale (“Grades”). The computer vision system captures each feature by measuring different magnitudes (“Measure”) using different methods that combine ventral and side views and alternate computer algorithms (“Method”) using two- and three-dimensional (2D and 3D, respectively) methods.

TABLE III

| | | Computer-based system | | SCI recovery |
|---|---|---|---|---|
| Feature | Grades | Measure | Method | phase |
| a | Ø = none | Angle for | a) Detection of joints from side | early |
| Limb | S = slight (<50%) | each joint | view | |
| Movement | E = extensive (>50%) of motion | | b) Detection of limb outline | |
| | range | | Fitting of 2D skeleton | |
| | | | Angle measurement for each | |
| | | | hindlimb joint | |
| b | Side (left (L) or right (R) side) | Symmetry of | Detection of joints from side view | intermediate |
| Trunk | Middle (normal) | hip position | Fitting of 3D skeleton | final |
| Position | | | Angle measurement of hip with | |
| | | | respect to horizontal plane | |
| | Prop (The rat props itself up with | Degree of | a) Detection of joints from side | intermediate |
| | the tail). Left (L) or right (R) side). | elevation | view | final |
| | | | Fitting of 3D skeleton | |
| | | | Distance of hip with respect to | |
| | | | horizontal plane | |
| | | | b) Reduction of illuminated | |
| | | | abdominal pixels from ventral | |
| | | | view. Increased illuminated tail | |
| | | | pixels | |
| c | Drag (the rat drags its abdomen | Degree of | a) Detection of Joints from side | intermediate |
| Abdomen | on the ground) | elevation | view | final |
| | Parallel (normal) | | Fitting of 3D Skeleton | |
| | High (the rat lifts its abdomen | | Distance of hip with respect to | |
| | higher than normal off the | | horizontal plane | |
| | ground) | | b) Reduction of illuminated | |
| | | | abdominal pixels from ventral view | |
| d | Sweep (sweeping motion of the | Presence, | Detection of hindlimb joints from | intermediate |
| Paw | limbs without weight support) | degree of | side view | final |
| Placement | | sweep | Fitting of 3D Skeleton | |
| | | | Angle change and frequency for | |
| | | | hindlimbs | |
| | No support | Degree of | a) Detection of Joints from side | intermediate |
| | Weight support (hindlimb | support | view | final |
| | extensor contraction and | | Fitting of 3D Skeleton | |
| | hindquarter elevation during | | Distance of hip with respect to | |
| | support) | | horizontal plane | |
| | | | b) Reduction of illuminated | |
| | | | abdominal pixels from ventral view | |
| | | | c) Elevation of hindquarter outline | |
| | | | from side | |
| e | Dorsal stepping (Rat uses foot | Presence | Detection of hindlimb paws from | intermediate |
| Stepping | dorsum to support weight, >4 | type and | ventral view | final |
| | times during 4-minute | frequency of | Detection of hindlimb paw side | |
| | observation period. Indicate | stepping | Measurement of hindlimb paw | |
| | dorsal to dorsal (D > D), plantar to | | side flips and their frequency | |
| | dorsal (P > D), or dorsal to plantar | | | |
| | (D > P). Rats are categorized as | | | |
| | frequent plantar steppers if they | | | |
| | have >4 dorsal steps per | | | |
| | hindlimb over the minute | | | |
| | observation period and Plantar | | | |
| | stepping. Ø = none, O = occasional | | | |
| | (<50%), F = frequent (51-94%), | | | |
| | C = consistent (>95%) | | | |
| f | Forelimb-hindlimb coordination | Degree of | a) Detection of Joints from side | intermediate |
| Coordination | Ø = none (0%), O = occasional | coordination | view | final |
| | (<50%), F = frequent (51-94%), | | Fitting of 3D Skeleton | |
| | C = consistent (>95%) | | Measurement of coordination of 4 | |
| | | | limbs | |
| | | | b) Detection of paws from ventral | |
| | | | view | |
| | | | Assessment of coordination of | |
| | | | paw movement | |
| g | Incidence of toe drags | Degree of | Detection of hindlimb toe dragging | intermediate |
| Toe | Ø = none (<5%), O = occasional | toe dragging | from ventral view | final |
| dragging | (<50%), F = frequent (51-94%), | | | |
| | C = consistent (>95%) | | | |
| h | Initial Contact: I = internal, | Angle of | a) Detection of Joints from side | intermediate |
| Paw | E = external, P = parallel rotation | hindlimb | view | final |
| position | on initial paw contact on ground | paws at | Fitting of 3D Skeleton | |
| Rotation on | Liftoff: I = internal, E = external, | contract and | Determination of direction of | |
| initial | P = parallel rotation on paw liftoff | liftoff | sagital plane | |
| contact | on ground. | | b) Detection of hindlimb paws | |
| | | | from ventral view | |
| | | | Angle with respect to sagital plane | |
| I | Yes/No | Degree of | a) Detection of Joints from side | intermediate |
| Trunk | | instability | view | final |
| instability | | | Fitting of 3D Skeleton | |
| | | | Determination of direction of | |
| | | | sagital plane | |
| | | | Deviation of sagital plane from | |
| | | | orthogonality | |
| J | Up/Down | Tail position | Detection of tail from side view | intermediate |
| Tail | | | | final |
| position | | | | |

The computer video system includes side (lateral) and ventral views. The side view provides the lateral outline of the rat, whereas the ventral view provides information about parts of the body in contact with the floor (abdomen, paws, limbs, tail). Image capturing from lateral views provides sufficient information for 2-dimensional models. Addition of ventral views provides a means for creating 3-dimensional models.

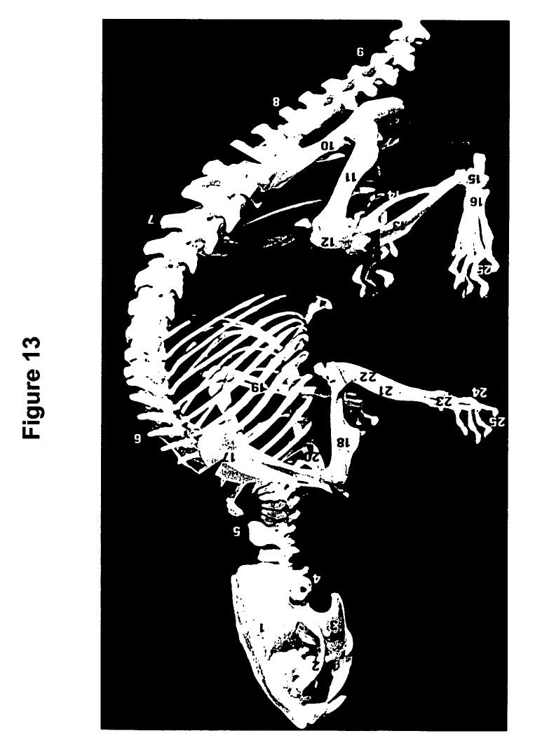

The most important features of early recovery from SCI involve the assessment of movement and flexion of the hindlimbs, and computer vision as utilized in this invention is ideal for capturing this kind of hindlimb movement. Therefore in one embodiment of the invention, hindlimb movement is measured from lateral view to assess early SCI recovery phase. Rats have color marks corresponding to the joints (and the foot to measure ankle flexion) as shown in FIG. 13. Marks are positioned by well-trained scientists familiar with rat anatomy. The system requires minimal human intervention and preparation in order to achieve a high throughput by combining smart computer vision algorithms to find limb outlines with minimal markings to provide joint landmarks.

In a second embodiment of the invention, assessment of intermediate and final phase recovery is made using both lateral and ventral views. Like the early phase assessment, intermediate and final phase assessment may be made with minimal human intervention and preparation, and therefore is amenable to high throughput.

For assessment of all phases of SCI and recovery, the video stream is analyzed to extract the joint xyz coordinates of all important BBB features (FIG. 5). In one embodiment of the invention the system uses a parallel approach: it finds the outline of the subject animal and fits a simple model consisting of an ellipse. Using the tail position, the rostral and caudal parts are defined and the limbs found, and at the same time the markings that are consistent with the fitted animal model are found.

The images are then fitted to an anatomically correct skeleton. A minimal skeleton, based on the anatomy of real rats, is used to fit the limbs and joints extracted from the video segmentation process. Restricting the angular movements of the model's limb segments minimizes possible video artifacts.

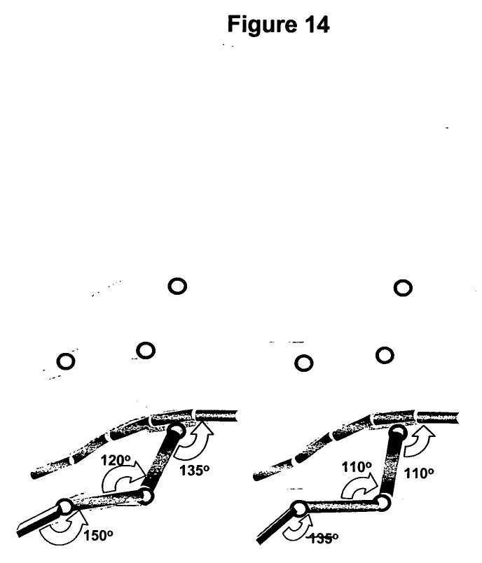

FIG. 14 shows the minimal rat skeleton used for the early recovery phase in one embodiment of the invention. For early recovery, the model fitting involves a simple two-dimensional fitting. For the intermediate and final recovery phases of SCI, and for the general assessment of motor function in other animal models, the system may incorporate three-dimensional skeleton fitting.

Computer vision may be used to calculate synthetic BBB scores. In one embodiment the system mimics the type of assessment required for the BBB scale in order to build a synthetic scale for assessment of SCI. Although the synthetic scale is continuous by nature, levels corresponding to each level of the BBB scale scores can be calculated.

Using the fitted skeleton model, the software calculates the angle between fitted segments. In one embodiment for assessment of early SCI recovery, the system assesses slight flexion of the hindlimbs, as required by the early recovery phase of the BBB scale (scores 0 to 7). FIG. 14 exemplifies the type of angle change to be measured.

The system may include a computer interface that allows a well-trained scientist to observe a video and the corresponding computer analysis and mark the frames in which the analysis was faulty. For example, a series of frames at 2 minutes into the trial may be marked for revision if the fitted angles do not correspond to the human assessment.

Angles for each joint calculated by the computer are of a continuous nature. In order to replicate the standard BBB scores the angles are transformed into a measure relative to motion range (mostly 180° ) and then the angles are categorized as ø=none, S=slight (<50%), and E=extensive (>50%).

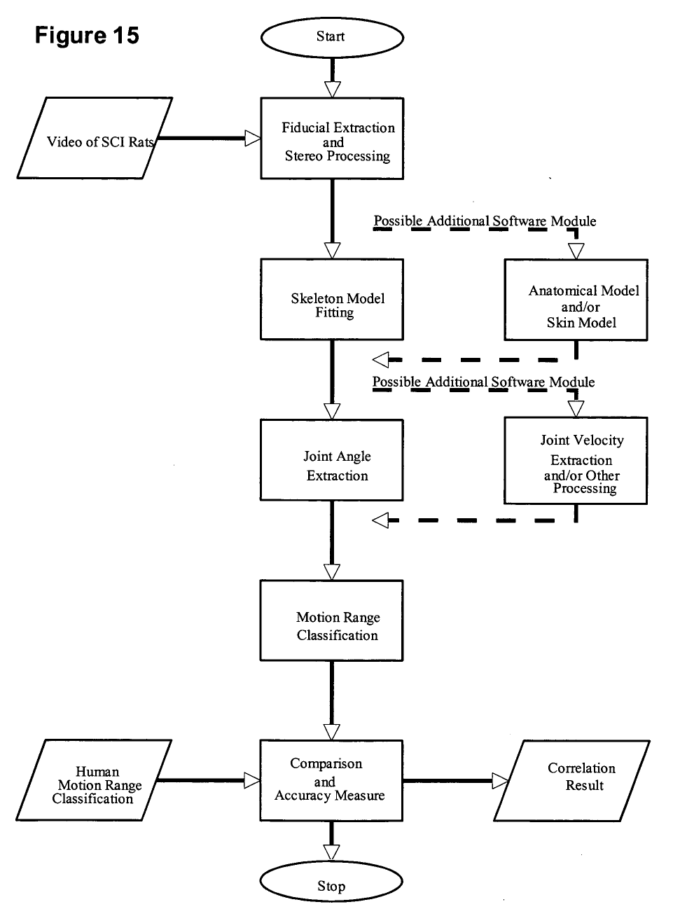

The flow diagram in FIG. 15 exemplifies the process. Angles are calculated by simply computing the relative orientations of adjacent segments in the skeleton model. If necessary, additional terms may be included to model skin elasticity and compound joint geometry.

The computer skeleton also may be extended from a two-dimensional model of the hindlimbs to a three-dimensional model of all limbs, spine and tail. In this aspect of the invention, the system may use several features: 1. Ventral view; 2. Lateral view; and 3. Stereovision to capture three-dimensional view of the subject animal. These aspects of the invention, described in detail in the context of SCI assessment, also are relevant to most other applications of the invention.

1. Ventral View

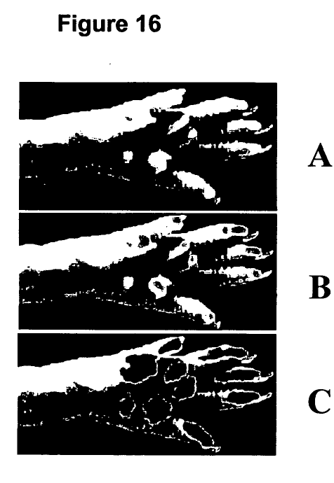

From the ventral view, the aim is to capture the position of the paws, the amount of pressure exerted on the abdomen, and an outline of a paw pressed between the abdomen and the glass (as when the rats lie on a side). See FIG. 16. It may be used to estimate plantar pressure by way of the color-illuminated floor feature of the arena. Whereas for the BBB scale an estimate of the force exerted through the paws is not strictly necessary, it is an important component to estimate shifting of balance from the abdomen to the limbs as rats recover from SCI, and in the long term, it also helps build a physiologically sensible motor movement model for rodents.

As an example, hindpaw position is analyzed as follows: The spatiotemporal position of the paws is used to estimate limb coordination. To differentiate plantar from dorsal paw position, one may use one or more techniques such as finding the outline and other features of the hindpaws; and marking the dorsal side of the hindpaws (e.g. with an “x”) to help differentiate between the two sides. FIGS. 6A and 16B show an example of shift between plantar and dorsal position.

When the rats shift their body weight away from the abdomen, their weight supported through plantar pressure can be estimated. FIGS. 6 and 16 show examples of a rat in different phases of recovery, as it supports more and more weight with its limbs. In FIG. 6, for example, illuminated pixels show considerable weight supported by the abdomen and contact of the floor by the tail (FIGS. 6A, B) during the early phase of SCI recovery. No illuminated pixels in FIG. 6C shows weight has been lifted and is supported exclusively by the limbs, and that the tail is now elevated. FIG. 16 shows a more detailed analysis of the hindpaw as more and more weight is being supported by the corresponding limbs (FIGS. 16A-16C).

In one embodiment of the invention, to assess the intermediate and final phase of SCI recovery, and for the assessment of motor function in other animal models of neurological dysfunction, the information obtained from the ventral and the lateral views is combined to construct each of the 21 levels of the BBB scale or to build an appropriate to motor ability score for each animal. Table III shows the particular features to be used for a synthetic, full BBB scale.

The ventral view allows paw print analysis to assess gait and motor coordination. A typical print of a normal mouse is depicted in FIG. 8. Although a detailed spatiotemporal analysis of gait is not necessary for the BBB scale, apart from an estimate of limb coordination, the computer system captures all necessary information to build a biomechanical model of rat motor function, which can be used for the study of subtle improvements, i.e., recovery.

Table IV shows the features that should be captured from the ventral view for the successful scoring of the BBB scale. These features are combined with the information obtained from the lateral view before scores are calculated.

TABLE IV

| | | Computer-based system | |
|---|---|---|---|
| | | VENTRAL VIEW | |
| Feature | Grades | Measure | Method |
| a | Prop (The rat props itself up with the | Degree of | Reduction of illuminated |
| Trunk Position | tail). Left (L) or right (R) side). | elevation | abdominal pixels. Increased |
| | | | illuminated tail pixels |
| b | Drag (the rat drags its abdomen on | Degree of | Reduction of illuminated |
| Abdomen | the ground) | elevation | abdominal pixels |
| c | No support | Degree of | Reduction of illuminated |
| Paw Placement | Weight support (hindlimb extensor | support | abdominal pixels. |
| | contraction and hindquarter elevation | | |
| | during support) | | |
| d | Dorsal stepping (Rat uses foot | Presence, | Detection of hindlimb paws |
| Stepping | dorsum to support weight, >4 times | type and | Detection of hindlimb paws |
| | during 4-minute observation period. | frequency | side |
| | Indicate dorsal to dorsal (D > D), | of stepping | Measurement of hindlimb |
| | plantar to dorsal (P > D), or dorsal to | | paw side flips and their |
| | plantar (D > P). Rats are categorized | | frequency |
| | as frequent plantar steppers if they | | |
| | have >4 dorsal steps per hindlimb | | |
| | over the minute observation period | | |
| | and Plantar stepping. Ø = none, | | |
| | O = occasional (<50%), F = frequent | | |
| | (51-94%), C = consistent (>95%) | | |
| e | Forelimb-hindlimb coordination | Degree of | Detection of paws |
| Coordination | Ø = none (0%), O = occasional (<50%), | coordination | Assessment of coordination |
| | F = frequent (51-94%), C = consistent | | of paw movement |
| | (>95%) | | |
| f | Incidence of toe drags | Degree of | Detection of hindlimb toe |
| Toe dragging | Ø = none (<5%), O = occasional (<50%), | toe | dragging |
| | F = frequent (51-94%), C = consistent | dragging | |
| | (>95%) | | |
| g | Initial Contact: I = internal, E = external, | Angle of | Detection of hindlimb paws |
| Paw position | P = parallel rotation on initial paw | hindlimb | Angle with respect to sagital |
| Rotation on | contact on ground | paws at | plane |
| initial contact | Liftoff: I = internal, E = external, | contract | |
| | P = parallel rotation on paw liftoff on | and liftoff | |
| | ground. | | |

2. Lateral view

From the lateral view, the system captures the position of the limbs, the amount of support of the abdomen, the stability of the body and position of the tail. Pairs of lateral view cameras permit stereovision processing. After background subtraction, feature recognition and model fitting, the computer algorithms extract the information necessary to calculate BBB scores or a similar motor ability score. Table V shows the features that is captured from the side view.

TABLE V

| | | Computer-based system | |
|---|---|---|---|
| | | LATERAL VIEW | |
| Feature | Grades | Measure | Method |
| a | Ø = none | Angle for | a) Detection of joints |
| Limb | S = slight (<50%) | each joint | b) Detection of limb outline |
| Movement | E = extensive (>50%) of motion | | Fitting of 3D skeleton (2D during |
| | range | | Phase I) |
| | | | Angle measurement for each |
| | | | hindlimb joint |
| b | Side (left (L) or right (R) side) | Symmetry of | Detection of joints |
| Trunk | Middle (normal) | hip position | Fitting of 3D skeleton |
| Position | | | Angle measurement of hip with |
| | | | respect to horizontal plane |
| | Prop (The rat props itself up with | Degree of | Detection of joints |
| | the tail). Left (L) or right (R) side). | elevation | Fitting of 3D skeleton |
| | | | Distance of hip with respect to |
| | | | horizontal plane |
| c | Drag (the rat drags its abdomen on | Degree of | Detection of Joints |
| Abdomen | the ground) | elevation | Fitting of 3D skeleton |
| | Parallel (normal) | | Distance of hip with respect to |
| | High (the rat lifts its abdomen | | horizontal plane |
| | higher than normal off the ground) | | |
| d | Sweep (sweeping motion of the | Presence | Detection of hindlimb joint |
| Paw | limbs without weight support) | and degree | Fitting of 3D skeleton |
| Placement | | of sweep | Angle change and frequency for |
| | | | hindlimbs |
| | No support | Degree of | a) Detection of joints |
| | Weight support (hindlimb extensor | support | Fitting of 3D skeleton |
| | contraction and hindquarter | | Distance of hip with respect to |
| | elevation during support) | | horizontal plane |
| | | | b) Elevation of hindquarter outline |
| | | | from side view |
| e | Forelimb-hindlimb coordination | Degree of | Detection of joints |
| Coordination | Ø = none (0%), O = occasional | coordination | Fitting of 3D skeleton |
| | (<50%), F = frequent (51-94%), | | Measurement of coordination of 4 |
| | C = consistent (>95%) | | limbs |
| f | Initial Contact: I = internal, | Angle of | Detection of joints |
| Paw | E = external, P = parallel rotation on | hindlimb | Fitting of 3D skeleton |
| position | initial paw contact on ground | paws at | Determination of direction of |
| Rotation on | Liftoff: I = internal, E = external, | contract and | sagital plane |
| initial | P = parallel rotation on paw liftoff on | liftoff | |
| contact | ground. | | |
| g | Yes/No | Degree of | a) Detection of Joints |
| Trunk | | instability | Fitting of 3D skeleton |
| instability | | | Determination of direction of |
| | | | sagital plane |
| | | | Deviation of sagital plane from |
| | | | orthogonality |
| h | Up/Down | Tail position | Detection of tail |
| Tail position | | | |

3. Stereo Three-Dimensional Vision

To support the assessment of the intermediate and late recovery phases of SCI using the BBB scale or other motor function evaluation scale in other animal models, the system acquires accurate 3D position of the animal's limbs and joints. To help locate the joints of the subject, the system may use marks on the animal's fur corresponding to the underlying physical structure and use computer vision techniques to accurately recover the continuous 3D positions of these marks from live video.

Automatic assessment of gait and motor coordination in mice is of value for many other models of motor dysfunction, and, in general, for any novel mutant in which the function of a gene is being investigated.

1. An automated system for analyzing motor behavior in an animal, comprising:
an arena having a floor and sidewalls, said floor and sidewalls defining an interior space, and wherein said floor and sidewalls allow for observations of an animal confined in said arena;
a plurality of video cameras positioned to provide a plurality of views of said animal, in a plurality of axes; and
a computer system comprising computer vision technology, wherein said computer system is connected to said cameras so as to capture images of said animal's motor behavior from said cameras, and analyze said images, wherein said analysis includes measurement of at least one feature on a continuous scale, to assess said animal's motor behavior based on comparing said motor behavior of said animal with a baseline motor behavior.

2. The system of claim 1, wherein said motor behavior includes one or more of the following: locomotor coordination, locomotor activity, equilibrium, and posture.

3. The system of claim 1, wherein said plurality of views includes at least one ventral view and one lateral view.

4. The system of claim 1, wherein said arena is a running wheel.

5. The system of claim 1, wherein said video cameras are positioned outside said sidewalls.

6. The system of claim 5, wherein said video cameras provide high-resolution images.

7. The system of claim 1, wherein one or more of said video cameras is a thermographic camera.

8. The system of claim 5, wherein one or more of said video cameras is connected to said computer system via a high-speed digital interface.

9. The system of claim 5, wherein said plurality of cameras are arranged as two stereo pairs.

10. The method of claim 9,wherein said stereo pairs are positioned at right angles to one another.

11. The system of claim 9, wherein four camera pairs are deployed.

12. The system of claim 1, wherein said computer vision technology comprises visual segmentation.

13. The system of claim 1, wherein said computer system uses stereovision algorithms.

14. The system of claim 1, wherein said floor of said arena is color illuminated, and said computer system is capable of using captured images of said color illumination to determine said animal's abdomen position and paw position and pressure.

15. The system of claim 1, wherein said analysis includes a determination of the spatiotemporal position of said animal's paws.

16. The system of claim 15, wherein said computer system assesses limb coordination of said animal using said paw spatiotemporal position.

17. The system of claim 1 further comprising a computer constructed synthetic BBB scale based on continuous measures, and wherein said analysis includes a determination of one or more BBB features selected from the group consisting of: limb movement, trunk position, abdomen, paw placement, stepping, coordination, toe dragging, predominant paw position, trunk instability, and tail position.

18. The system of claim 17 wherein all of said BBB features are determined.

19. The system of claim 17, wherein said analysis further includes a determination of xyz coordinates of said BBB features, an elliptical outline of said animal, rostral and caudal parts of said animal, limb locations, or location of joint markings.

20. The system of claim 19, wherein said computer system fits said determined features, based on said elliptical outline of said animal, to an anatomically correct computer skeleton.

21. A method for analyzing motor behavior in an animal, comprising the steps of:
placing said animal in an arena having a floor and sidewalls, said floor and sidewalls defining an interior space, and wherein said floor and sidewalls allow for observations of an animal confined in said arena;
capturing images from a plurality of views of said animal from a plurality of video cameras positioned in a plurality of axes;
analyzing said captured images of said animal's motor behavior, using a computer system comprising computer vision technology, wherein said computer system is connected to said cameras and wherein said analyzing includes measuring at least one feature on a continuous scale;
classifying information from said analyzing using said computer system; and assessing said animal's motor behavior based on comparing said motor behavior of said animal with a baseline motor behavior.

22. The method of claim 21, wherein said motor behavior includes one or more of the following: locomotor coordination, locomotor activity, equilibrium, and posture.

23. The method of claim 21, wherein said plurality of views includes at least one ventral view and one lateral view.

24. The method of claim 21, wherein said arena is a running wheel.

25. The method of claim 20, wherein said step of capturing images of ventral and lateral views of said animal comprises configuring said cameras for stereovision processing.

26. The method of claim 21, wherein said step of analyzing said captured images comprises using video segmentation.

27. The method of claim 21, wherein said floor of said arena is color illuminated, and said computer system is capable of using captured images of said color illumination to determine the animal's abdomen and paw position and pressure.

28. The method of claim 21 further comprising the step of comparing and correlating said classified information to database classifications.

29. The method of claim 21 further comprising the step of classifying said information within a range defined for animals of the same type as that of said animal.

30. The method of claim 21 further comprising the step of comparing said animal range classification to a known human range classification.

31. The method of claim 28 further comprising the step of comparing and correlating said classification to determine a level of motor function.

32. The method of claim 21, wherein said step of analyzing said captured images comprises fitting a simple two-dimensional model to joint positions of said animal's hindlimbs and estimating joint angles of said hindlimbs.

33. The method of claim 32, wherein said step of analyzing said captured images further comprises extending said two-dimensional model to a three dimensional model of all limbs, spine and tail.

34. The method of claim 21, further comprising the step of measuring any one or more of limb movement, trunk position, abdomen position, paw placement, coordination, paw position on initial contact, trunk instability, tail position, or posture.

35. The method of claim 27, further comprising the step of measuring any one or more of trunk position, abdomen position, paw placement, stepping, coordination, toe dragging, posture, or paw position rotation on initial contact based on said animal contact with said color-illuminated floor.

36. The method of claim 21, further comprising the steps of administering to said animal, prior to placing said animal in said arena, a pharmaceutical agent having known or potential motor-behavioral effects.

37. The method of claim 21, further comprising the step of optionally repeating one or more of said steps at specific time intervals to assess temporal changes in motor function over time.

38. The method of claim 21 further comprising the step of optionally repeating one or more of the steps at specific time intervals to assess temporal changes related to withdrawal.

39. The method of claim 21, wherein said animal is a model for a condition that affects motor behavior.

40. The method of claim 39, wherein said animal is a model of spinal cord injury, a neurodegenerative disease, or a neurological condition affecting motor behavior.

41. The method of claim 21, wherein said motor behavior is associated with pain or inflammation in said animal.

42. The method of claim 41, wherein said pain or inflammation in said animal is treated with a therapeutic agent.

43. The method of claim 21, further comprising the step of administering to said animal a therapeutic agent intended to improve or deteriorate motor function prior to placing said animal in said arena.

44. The method of claim 21, further comprising the step of physically influencing the animal's neural pathways or brain in a manner intended to improve motor function, prior to placing said animal in said arena.

45. The method of claim 40, wherein said neurodegenerative disease is selected from the group consisting of Huntington's disease, Parkinson's disease, ALS, peripheral neuropathies, and dystonia.

46. The method of claim 41, wherein said animal model is created by a method selected from the group consisting of transgenic mutation, knockout mutation, lesion of a neural pathway, and lesion of a brain region.
